(19) United States
(12) Patent Application Publication
(10) Pub. No.: US 2015/0092790 A1
(43) Pub. Date: Apr. 2, 2015

(54) INTERNET PROTOCOL TELEVISION AND OPERATING METHOD THEREOF

(71) Applicant: LG ELECTRONICS INC., Seoul (KR)

(72) Inventors: Beomki PARK, Seoul (KR); Hojong KANG, Seoul (KR); Yongha YU, Seoul (KR); Donguk KIM, Seoul (KR)

(73) Assignee: LG ELECTRONICS INC., Seoul (KR)

(21) Appl. No.: 14/488,997

(22) Filed: Sep. 17, 2014

(30) Foreign Application Priority Data
Sep. 30, 2013 (KR) 10-2013-0116673

(51) Int. Cl. H04L 29/06

(52) U.S. Cl. CPC H04L 65/604; H04L 65/4076; H04L 65/607
USPC 370/466

(57) ABSTRACT

An IPTV (Internet Protocol TeleVision) including an Ethernet driver configured to receive a broadcast signal, extract a data packet from the received broadcast signal, and store the extracted data packet in a memory; an IP tuner configured to convert the extracted data packet and store the converted data packet as reproduction data accessible by a decoder; and an output unit configured to output the reproduction data decoded by the decoder.

### CROSS-REFERENCE TO RELATED APPLICATIONS

Pursuant to 35 U.S.C. §119(a), this application claims the benefit of earlier filing date and right of priority to Korean Patent Application No. 10-2013-0116673, filed on Sep. 30, 2013, the contents of which are incorporated by reference herein in their entirety.

### BACKGROUND OF THE INVENTION

1. Field of the Invention

The present invention relates to an IPTV (Internet Protocol TV), and more specifically, to an IPTV having enhanced data processing efficiency and a method for driving the same.

2. Discussion of the Related Art

An IPTV typically uses UDP (User Datagram Protocol/IP (Internet Protocol)) as its transmission protocol for real-time broadcast data transmission, and uses RTP (Real-time Transport Protocol) as its transmission protocol for transmission of additional data. The data processing procedure of a related art IPTV 1 is represented in FIG. 1.

That is, FIG. 1 schematically illustrates a broadcast signal processing procedure of a related art IPTV. Referring to FIG. 1, the IPTV 1 includes an Ethernet driver 10, an IP (Internet Protocol) layer 20, a UDP (User Datagram Protocol) layer 30, an IPTV player 40, and a decoder 50.

If a broadcast signal is received through the Ethernet driver 10, the received broadcast signal passes through the IP layer 20 and the UDP layer 30, and the IP header and the UDP header of the data packet in the received broadcast signal are processed. The IP/UDP layers 20 and 30 parse the IP/UDP headers and repeatedly perform the task of calculating a checksum value in order to check packet errors. Because the broadcast signal is received with the same pattern in the IPTV, such repeated task may be meaningless.

Further, the data output from the UDP layer 30 is transferred to the IPTV player 40, and the IPTV player 40 examines the RTP header from the data received from the UDP layer 30 to perform a proper process, stores the RTP payload in a buffer memory so the decoder 50 can access and process it, and then delivers it to the decoder 50.

In other words, as described above, the related art IPTV 1 requires the process of copying and storing the payload of the UDP packet in the buffer memory and copying and storing the payload of the RTP packet in the buffer memory. The repetition of such process of copying and storing in the buffer memory deteriorates the performance of the IPTV system. In addition, the decoder 50 can then perform a broadcast reproduction function based on the data delivered from the IPTV player 40.

As described above, the above process is repeatedly performed in high-speed broadcast signal processing for achieving high-quality images, and this increases the IPTV system load. As a result, the related art IPTV system suffers from a deterioration of system performance.

### SUMMARY OF THE INVENTION

An object of the present invention is to provide an IPTV that enhances data processing efficiency by previously performing a protocol-related processing procedure on broadcast signals in an Ethernet driver or IP tuner and a method for driving the same.

Another object of the present invention is to provide an IPTV that enhances data processing efficiency by storing a result of performing a protocol-related processing procedure on the broadcast signals in the size and form appropriate for decoding and a method for driving the same.

Still another object of the present invention is to provide an IPTV that enhances data processing efficiency by reducing the number of times of storing in the memory, as required during the broadcast signal processing procedure and a method for driving the same.

To achieve the above objects, according to an embodiment of the present invention, an IPTV (Internet Protocol TeleVision) may include an Ethernet driver; an IP tuner; a buffer memory; an IPTV player; and a decoder.

The Ethernet driver can be configured to receive a broadcast signal, extract a data packet from the received broadcast signal, and store the extracted data packet. The IP tuner can also be configured to convert the extracted data packet into a form that can be accessed and utilized by the decoder and to store the converted data packet in the buffer memory.

The IPTV player can be configured to transfer a memory address storing the converted data packet to the decoder, and the decoder can be configured to access the converted data packet stored in the buffer memory based on the memory address to perform a broadcast reproduction function.

The broadcast signal may include real-time broadcast data transmitted based on a first protocol and additional information transmitted based on a second protocol.

The Ethernet driver can be configured to extract the data packet from the broadcast signal by performing the first protocol-related process on the received broadcast signal. The IP tuner can be configured to perform the second protocol-related process on the extracted data packet and to store the data packet that has undergone the second protocol-related process in a specific region assigned to the decoder in the buffer memory.

The IP tuner includes an IP tuner controller configured to receive information for performing an operation requested by the IPTV player from the IPTV player; a packet extracting unit configured to extract a data packet necessary for performing the requested operation from the extracted data under control of the IP tuner controller; a process treating unit configured to perform the second protocol-related process on the data packet extracted by the packet extracting unit under control of the IP tuner controller; and a data managing unit configured to store the data packet processed by the process treating unit in a specific region of the buffer memory assigned to the decoder under control of the IP tuner controller.

The data managing unit can be configured to store only payload of the data packet processed by the process treating unit in the specific region of the buffer memory. If the storing in the specific region of the buffer memory is complete, the IPTV player can be configured to transfer an address of the specific region to the decoder.

The Ethernet driver can be configured to extract the data packet from the broadcast signal by performing the first protocol-related process and the second protocol-related process on the received broadcast signal.

To achieve the above objects, according to an embodiment of the present invention, a method for driving an IPTV, the IPTV including an Ethernet driver, an IP tuner, a buffer memory, an IPTV player, and a decoder. The method includes by the Ethernet driver, receiving a broadcast signal, extracting a data packet from the received broadcast signal and storing the extracted data packet; by the IP tuner, converting the extracted data packet into a form that may be accessed and utilized by the decoder and storing the converted data packet in the buffer memory; by the IPTV player, transferring a memory address storing the converted data packet to the decoder; and by the decoder, accessing the buffer memory based on the memory address to perform an audio and video reproducing function.

The broadcast signal may include real-time broadcast data transmitted based on a first protocol and additional information transmitted based on a second protocol.

The Ethernet driver can be configured to extract the data packet from the broadcast signal by performing the first protocol-related process on the received broadcast signal, and the IP tuner can be configured to perform the second protocol-related process on the extracted data packet and to store the data packet that has undergone the second protocol-related process in a memory block assigned to the decoder in the buffer memory.

The Ethernet driver can be configured to extract the data packet from the broadcast signal by performing the first protocol-related process and the second protocol-related process on the received broadcast signal.

The above-described IPTV driving method according to an embodiment of the present invention may be implemented by executing a computer program for realizing the mobile terminal driving method stored in a recording medium readable by a computer.

By the IPTV and its driving method according to an embodiment of the present invention, a protocol-related processing procedure for a broadcast signal is previously performed in an Ethernet driver or IP tuner, thus leading to an enhancement in data processing efficiency.

By the IPTV and its driving method according to an embodiment of the present invention, a result of performing the protocol-related processing procedure on the broadcast signal is stored in the size and form appropriate for decoding, thus leading to an enhancement in data processing efficiency.

By the IPTV and its driving method according to an embodiment of the present invention, the number of times of storing in memory, required during the broadcast signal processing procedure is reduced, thus leading to an enhancement in data processing efficiency.

An additional scope of applicability of the present invention will be apparent from the following detailed description. However, it may be appreciated by those of ordinary skill in the art that various changes and modifications may be made thereto without departing from the spirit and scope of the present invention, and it should be noted that the specific embodiments set forth herein are provided only for an example.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 schematically illustrates a broadcast signal processing procedure of a related art IPTV;

FIG. 2 is a block diagram illustrating an IPTV according to an embodiment of the present invention;

FIG. 3 is a flowchart illustrating a method for driving an IPTV according to an embodiment of the present invention;

FIG. 4 is an overview illustrating an example of performing a protocol-related process including header removal in an IPTV according to an embodiment of the present invention;

FIG. 5 is a block diagram illustrating an example IP tuner included in an IPTV according to an embodiment of the present invention; and

FIG. 6 is a flowchart illustrating a method for driving an IPTV including a data processing procedure performed in an IP tuner as shown in FIG. 5.

### DETAILED DESCRIPTION

The foregoing objects, features, and advantages of the present invention may be apparent from the following detailed description taken in conjunction with the accompanying drawings. Hereinafter, preferred embodiments of the present invention will be described with reference to the drawings. The same reference numerals are used to denote the same elements throughout the specification. When determined to make the gist of the present invention unnecessarily unclear, the detailed description of the known art will be omitted.

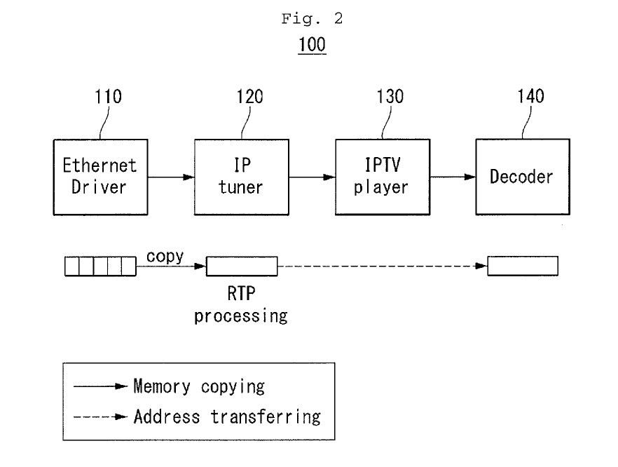

Hereinafter, image outputting devices according to an embodiment of the present invention will be described in detail with reference to the drawings. In particular, FIG. 2 is a block diagram illustrating an IPTV 100 according to an embodiment of the present invention. Referring to FIG. 2, the IPTV 100 includes an Ethernet driver 110, an IP tuner 120, an IPTV player 130, and a decoder 140. The IPTV 100 may have more or less components than those shown in FIG. 2. Hereinafter, the components are described one by one.

The Ethernet driver 110 can receive a broadcast signal, extract a data packet from the received broadcast signal and store the extracted data packet. The broadcast signal may include real-time broadcast data transmitted based on a first protocol and additional information transmitted based on a second protocol. Here, the first protocol may be UDP, and the second protocol may be RTP. However, the scope of the present invention is not limited thereto.

The Ethernet driver 110 can extract the data packet from the broadcast signal by performing a first protocol-related process on the received broadcast signal. For example, the Ethernet driver 110 can extract the data packet from the broadcast signal by performing an IP/UDP-related process containing a process of removing the IP header and UDP header for the received broadcast signal.

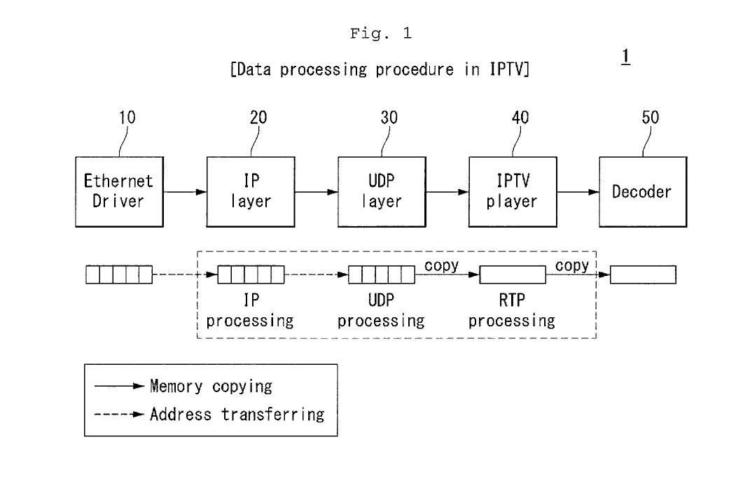

Such processes correspond to the processes performed in the IP layer 20 and the UDP layer 30 of the related art IPTV 1 as shown in FIG. 1. That is, the IPTV 100 performs such processes in the Ethernet driver 110, thus mitigating the load to the data processing procedure in the IPTV 100.

According to an embodiment, the Ethernet driver 110 can also perform the second protocol-related process on the received broadcast signal. For example, the Ethernet driver 110 can perform an RTP-related process containing a process of removing the RTP header. Such process corresponds to the process performed by the IPTV player 40 of the related art IPTV 1. That is, the IPTV 100 can perform such processes in the Ethernet driver 110, thus mitigating the load to the data processing procedure.

Further, the IP tuner 120 converts the data packet extracted by the Ethernet driver 110 in the form that may be accessed and utilized by the decoder and stores it in a buffer memory. For example, the IP tuner 120 can store the data packet output from the Ethernet driver 110 in a specific block of the buffer memory assigned to the decoder 140.

In this instance, the data packet is converted in the size and form utilized by the decoder 140 and is stored in the specific block. Accordingly, the decoder 140 can immediately access the specific block to perform a broadcast reproduction function. Because the decoder 140 in the IPTV 100 immediately accesses the data packet processed by the IP tuner 120 to perform the broadcast reproduction function, the IPTV 100 can have further enhanced performance as compared with the related art IPTV.

When the first protocol-related process has been performed by the Ethernet driver 110, the IP tuner 120 can perform the second protocol-related process on the data packet output from the Ethernet driver 110. For example, the IP tuner 120 can perform an RTP-related process including a process of removing the RTP header for the data packet output from the Ethernet driver 110.

However, when the second protocol-related process is performed by the Ethernet driver 110, the IP tuner 120 may not perform the second protocol-related process. Meanwhile, the Ethernet driver 110 and the IP tuner 120 may have partially common hardware-like or software-like configurations. The IPTV player 130 can also transfer a memory address containing the converted data packet to the decoder 140.

The decoder 140 can then access the converted data packet stored in the buffer memory based on the memory address to perform the broadcast reproduction function. Meanwhile, in the block corresponding to the memory address is stored the data extracted from the broadcast signal not in a unit of data packets but in the size and form that can be immediately accessed and utilized by the decoder 140. Thus, the IPTV 100 has an enhanced performance as compared with the related art IPTV 1.

As described above in connection with FIG. 2, the memory copying process is performed only once in the data processing procedure of the IPTV 100 according to an embodiment of the present invention. However, in the data processing procedure of the related art IPTV 1 shown in FIG. 1, the memory copying process occurs twice. As such, the IPTV 100 according to an embodiment of the present invention has an enhanced data processing efficiency because of the reduction in the number of times of performing the memory copying process.

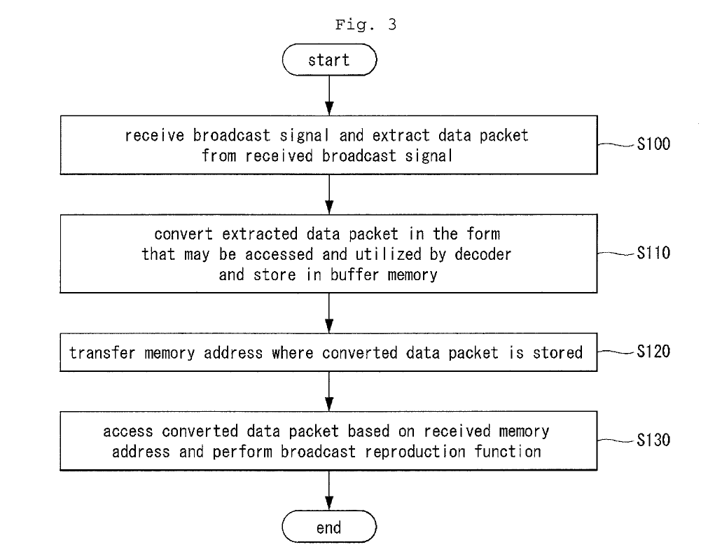

Next, FIG. 3 is a flowchart illustrating an example method for driving an IPTV 100 according to an embodiment of the present invention. As shown, if a real-time broadcast signal is received through the Ethernet driver 110, the Ethernet driver 110 extracts a data packet from the received broadcast signal (S100). At this time, the Ethernet driver 110 may perform a process, such as header removal corresponding to a related protocol, on the received broadcast signal.

Then, the IP tuner 120 converts the data packet extracted by the Ethernet driver 110 into the form that can be accessed and utilized by the decoder 140 and stores it in the buffer memory (S120). Further, the IP tuner 120 may also perform a process, such as header removal, corresponding to a necessary related-protocol, on the extracted data.

If storing the data converted by the IP tuner 120 is complete, the IPTV player 130 transfers the memory address containing the converted data packet to the decoder 140 (S120), and the decoder 140 can immediately access the converted data packet based on the received memory address to perform a broadcast reproduction function (S130).

Thus, the above driving method has the features of (1) the protocol-related process for the received broadcast signal is performed at a broadcast signal reception end including the Ethernet driver 110 and the IP tuner 120, (2) memory copying in the process of obtaining data used for reproducing broadcast is performed only once, and (3) the data used for reproducing broadcast is stored in the form that can be immediately accessed and reproduced by the decoder only by the process at the broadcast signal reception end. Based on such features, the IPTV 100 according to an embodiment of the present invention offers further enhanced data processing efficiency as compared with the related art IPTV 1.

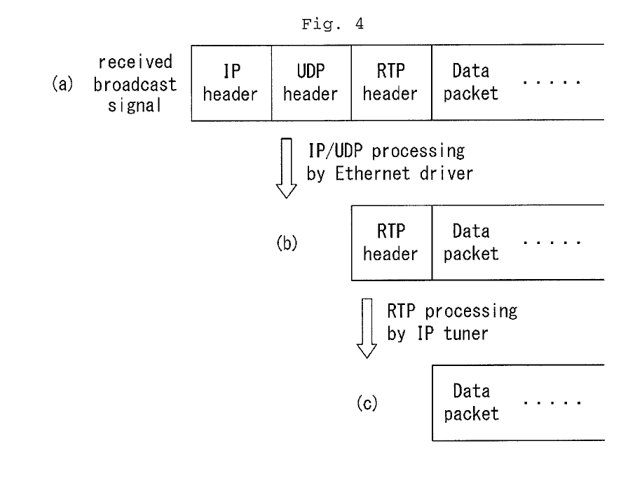

Next, FIG. 4 illustrates an example of performing a protocol-related process including, e.g., header removal, in an IPTV 100 according to an embodiment of the present invention. In particular, FIG. 4(a) shows the data architecture of a broadcast signal received through the Ethernet driver 110. Referring to FIG. 4(a), the received broadcast signal includes an IP header, a UDP header, an RTP header, and a data packet.

The Ethernet driver 110 can perform an IP/UDP-related process for removing the IP header and the UDP header on the received broadcast signal. As shown in FIG. 4(b), the received broadcast signal is then rendered to have the form including the RTP header and the data packet.

The IP tuner 120 can perform an RTP-related process including RTP header removal on the data output from the Ethernet driver 110. As shown in FIG. 4(c), the received broadcast signal can be then processed to have the structure that has only the data packet. Further, the IP tuner 120 can store only the RTP payload of the data packet in the memory block assigned to the decoder 140 in the size and form that can be immediately accessed and utilized by the decoder 140.

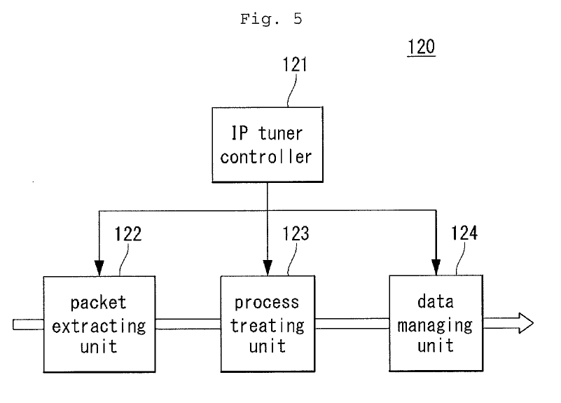

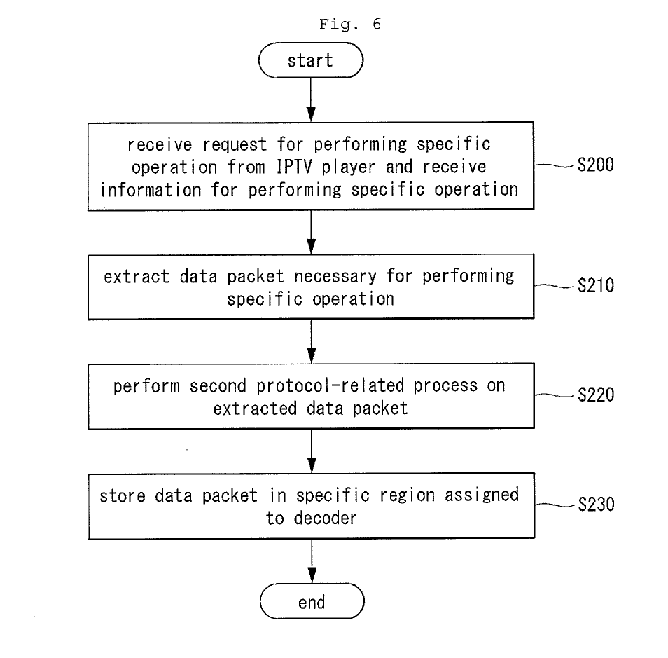

FIG. 5 is a block diagram illustrating an example IP tuner 120 included in an IPTV 100 according to an embodiment of the present invention, and FIG. 6 is a flowchart illustrating an example method for driving the IPTV 100 including a data processing procedure performed in the IP tuner 120 shown in FIG. 5. Meanwhile, the example IP tuner 120 shown in FIG. 5 is related to when a protocol-related process has been primarily conducted on the broadcast signal received by the Ethernet driver 110.

Referring to FIG. 5, the IP tuner 120 includes an IP tuner controller 121, a packet extracting unit 122, a process treating unit 123, and a data managing unit 124. In addition, the IP tuner 120 may have more or less components than those shown in FIG. 5.

As shown in FIG. 6, the IP tuner controller 121 receives a request for performing a specific operation from the IPTV player 130 and receives information for performing the requested specific operation from the IPTV player 130 (S200). Here, the information received from the IPTV player 130 may contain an IP address corresponding to multimedia that should be received, port information, or the address and size of a memory in which the data should be stored. However, the scope of the present invention is not limited thereto.

The packet extracting unit 122 then extracts the data packet used for performing the specific operation under the control of the IP tuner controller 121 (S210). Here, what is subjected to the data packet extraction used for performing the specific operation is the data packet that has undergone the first protocol-related process in the Ethernet driver 110. The first protocol-related process may be the IP/UDP-related process.

More specifically, the packet extracting unit 122 searches for port information and IP address of the IP header in the data packet and outputs corresponding data to the RTP processing unit. Further, in order for high-speed data processing, the packet extracting unit 122 may omit the process on the other information of the IP/UDP header.

Thereafter, the process treating unit 123 can perform the second protocol-related process on the data packet extracted by the packet extracting unit 122 under the control of the IP tuner controller 121. Here, the second protocol-related process may be the RTP-related process including RTP header removal. In addition, the RTP-related process may further include a process of examining the RTP header of the data packet extracted by the packet extracting unit 122 to obtain error information or to obtain network quality information.

Further, the data managing unit 124 performs a function for storing the data packet processed by the process treating unit 123 in a specific region of the buffer memory assigned to the decoder 140 under the control of the IP tuner controller 121 (S230).

A specific example of the operation of the data managing unit 124 will now be described. First, the data managing unit 124 can perform a function of securing a specific block of the buffer memory corresponding to a specific function that is to be performed in response to a request from the IPTV player 130 and then storing only the payload of the data output from the process treating unit 123 in the specific block.

If the operation of storing the payload for the specific block is complete, a flag can be configured to indicate that the operation of writing the specific block in the header of the buffer memory has completed. Then, the IPTV player 130 periodically monitors the flag, and when it has been identified that the flag has been configured, deliver the memory address corresponding to the specific block to the decoder 140.

Then, the decoder 140 can access the specific block based on the received memory address and perform the specific function requested by the IPTV player 130 using the data stored in the specific block.

Each of the data processing methods performed in an IPTV according to an embodiment of the present invention, as described above, may be implemented in a program that may be executed by various computing means and may be recorded in a computer readable medium. The computer readable medium may include, alone or in combination, a program command, a data file, and/or a data architecture. The program recorded in the medium may be specially designed or configured for the present invention or may be known to those of ordinary skill in the computer software art.

The computer readable recording medium may include, for example, magnetic media, such as hard disks, floppy disks, and magnetic tapes, optical recording media, such as CD-ROMs and DVDs, magneto-optical media such as floptical disks, ROMs, RAMs, flash memories, and other hardware devices specially configured to store and execute program commands. The program may include, for example, machine language codes created by a compiler, as well as high level language codes that may be executed by a computer using an interpreter. The hardware devices may be configured in one or more software modules for performing the operation according to an embodiment of the present invention, and vice versa.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An IPTV (Internet Protocol TeleVision) comprising:
an Ethernet driver configured to receive a broadcast signal, extract a data packet from the received broadcast signal, and store the extracted data packet in a memory;
an IP tuner configured to convert the extracted data packet and store the converted data packet as reproduction data accessible by a decoder; and
an output unit configured to output the reproduction data decoded by the decoder.

2. The IPTV of claim 1, wherein the broadcast signal includes real-time broadcast data transmitted based on a first protocol and additional information transmitted based on a second protocol.

3. The IPTV of claim 2, wherein the first protocol includes UDP (User Datagram Protocol/IP (Internet Protocol)) and the second protocol include RTP (Real-time Transport Protocol).

4. The IPTV of claim 2, wherein the Ethernet driver is further configured to extract first header information from the received broadcast signal, and
wherein the IP tuner is further configured to extract second header information from the data packet and store a remaining data payload in a specific region assigned to the decoder in the memory.

5. The IPTV of claim 4, wherein the IP tuner comprises:
an IP tuner controller configured to receive information for performing an operation requested by the IPTV player from the IPTV player;
a packet extracting unit configured to extract a data packet user for performing the requested operation from the extracted data under control of the IP tuner controller;
a process treating unit configured to remove the second header information on the data packet extracted by the packet extracting unit under control of the IP tuner controller; and
a data managing unit configured to store the remaining data payload processed by the process treating unit in a specific region of the memory assigned to the decoder under control of the IP tuner controller.

6. The IPTV of claim 5, wherein the data managing unit is further configured to store only the remaining data payload of the data packet processed by the process treating unit in the specific region of the memory, and
wherein the IPTV player is configured to transfer an address of the specific region to the decoder when the storing in the specific region of the memory is complete.

7. The IPTV of claim 4, wherein the second header information directly follows the first header information.

8. The IPTV of claim 4, wherein the decoder is further configured to directly access the memory to decode the remaining data payload.

9. The IPTV of claim 4, wherein the decoder is further configured to access a specific block of the memory including the remaining data payload assigned to the decoder.

10. The IPTV of claim 2, wherein the Ethernet driver is further configured to extract first and second header information from the data packet and store a remaining data payload in a specific region assigned to the decoder in the memory, and
wherein the first header information corresponds to the first protocol and the second header information corresponds to the second protocol.

11. A method of controlling an IPTV (Internet Protocol TeleVision, the method comprising:
receiving, via an Ethernet driver of the IPTV a broadcast signal, extracting a data packet from the received broadcast signal, and storing the extracted data packet in a memory;
converting, via an IP tuner the extracted data packet and storing the converted data packet as reproduction data accessible by a decoder; and
outputting, via an output unit of the IPTV, the reproduction data decoded by the decoder.

12. The method of claim 11, wherein the broadcast signal includes real-time broadcast data transmitted based on a first protocol and additional information transmitted based on a second protocol.

13. The method of claim 12, wherein the first protocol includes UDP (User Datagram Protocol/IP (Internet Protocol)) and the second protocol include RTP (Real-time Transport Protocol).

14. The method of claim 12, further comprising:
extracting, via the Ethernet driver, first header information from the received broadcast signal; and
extracting, via the IP tuner, second header information from the data packet and storing a remaining data payload in a specific region assigned to the decoder in the memory.

15. The method of claim 14, wherein the IP tuner comprises:
an IP tuner controller configured to receive information for performing an operation requested by the IPTV player from the IPTV player;
a packet extracting unit configured to extract a data packet user for performing the requested operation from the extracted data under control of the IP tuner controller;
a process treating unit configured to remove the second header information on the data packet extracted by the packet extracting unit under control of the IP tuner controller; and
a data managing unit configured to store the remaining data payload processed by the process treating unit in a specific region of the buffer memory assigned to the decoder under control of the IP tuner controller.

16. The method of claim 15, further comprising:
storing, via the data managing unit, only the remaining data payload of the data packet processed by the process treating unit in the specific region of the memory; and
transferring, via the IPTV player, an address of the specific region to the decoder when the storing in the specific region of the buffer memory is complete.

17. The method of claim 14, wherein the second header information directly follows the first header information.

18. The method of claim 14, wherein the decoder directly accesses the memory to decode the remaining data payload.

19. The method of claim 14, further comprising:
accessing, via the decoder, a specific block of the memory including the remaining data payload assigned to the decoder.

20. The method of claim 12, further comprising:
extracting, via the Ethernet driver, first and second header information from the data packet and storing a remaining data payload in a specific region assigned to the decoder in the memory,
wherein the first header information corresponds to the first protocol and the second header information corresponds to the second protocol.
